(19) United States
(12) Patent Application Publication
(10) Pub. No.: US 2005/0204008 A1
(43) Pub. Date: Sep. 15, 2005

(54) System and method for controlling the downstream preservation and destruction of electronic mail

(76) Inventor: Marc Shinbrood, Palm Beach Gardens, FL (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/074,930

(22) Filed: Mar. 9, 2005

Related U.S. Application Data
(60) Provisional application No. 60/551,053, filed on Mar. 9, 2004.

(51) Int. Cl. G06F 15/16; H04L 9/00

(52) U.S. Cl. 709/206; 713/150

(57) ABSTRACT

A system and method for controlling the downstream preservation and destruction of electronic mail by encrypting the electronic mail and limiting access to the encrypted file based on registration of recipient e-mail addresses, and detection and restriction of output functionality available to the recipient. The registration procedure limits access to recipients included on an access control list, who receive a pre-configured reader and then authenticate their e-mail address to the reader via a known SMTP Server. The sender of an e-mail is provided with a dialog for determining the limitations on access to the e-mail by the recipient: whether the e-mail is to be inaccessible after a certain period of time, whether a recipient may copy or print the e-mail and/or its attachments, or whether a password is required to read the e-mail. These limitations comprise an access control policy applicable to the e-mail, the pre-configured reader being adapted to decrypt the e-mail and apply the policy.

This application claims the benefit of U.S. Provisional Application No. 60/551,053 entitled System and Method for Controlling the Downstream Preservation and Destruction of Electronic Mail filed on Mar. 9, 2004.

### BACKGROUND OF THE INVENTION

1. Field of the Invention

The present invention generally relates to electronic mail and in particular to mechanisms for control by the sender of what happens to the message and attachments in the hands of the recipient.

2. Background Description

Electronic mail is a commonplace method of communication for those with access to the Internet. It is easy and convenient. Most modern electronic mail handling programs (e.g. Outlook or Eudora) facilitate reply and forwarding of incoming messages and sending to a plurality of recipients. Communication using electronic mail is so convenient that it is often used without adequate attention to what may happen to the email after it leaves the sender.

It is well known in the art to use encryption techniques to prevent third parties from intercepting and reading electronic mail messages. However, most electronic mail handling systems do not provide the additional procedures that a sender must undertake to use encryption techniques. Furthermore, the greater concern for the sender may be in the persistence of the electronic mail message once it arrives at the intended recipient, who may forward the message or leave a printed copy in paper files or fail to delete the message after reading it.

### SUMMARY OF THE INVENTION

It is therefore an object of the present invention to provide a convenient interface for electronic mail programs so that the sender of an electronic mail message is able to determine whether a recipient can print or forward the message or any attachments to the message.

A further object of the invention is to permit the sender of an electronic mail message to determine the length of time the message will persist in any readable form.

The invention provides a self-contained system that allows the creator of an e-mail to control the disposition of the e-mail once it has been sent. This is done via settings made by the creator of the e-mail before the e-mail is sent. These settings comprise what is called the “e-mail control policy” (hereinafter “Policy”) applied to the e-mail, and control the following actions:
Access to the e-mail—Who can open and view the e-mail is limited to the recipients of the e-mail.
Distribution of the e-mail—the recipient can be denied the ability to print, forward and copy the e-mail.
Distribution of the e-mail attachments—the recipient can be denied the ability to print, forward and copy e-mail attachments, independently of controls on the email itself. For example, in one implementation of the invention the user can control the printing, forwarding and copying of any Microsoft Office attachment.
Expiration of the e-mail—the time period that the e-mail can be viewed and any allowed action (i.e. to print, forward or copy the email and/or attachments) can be taken can be limited. After the time period has expired, the recipient is blocked from viewing or manipulating the e-mail.
Password—A password can be assigned to the e-mail, so that a recipient must provide the password in order to view the e-mail and take any allowed action against the e-mail.
   It should be noted that if copying is not allowed for the message, screen capturing is blocked both for the message and the attachments when the recipient views them.

Before the product is initially used by a recipient, the recipient must authenticate his e-mail address. The product sent to the recipient initiates a dialog in which the recipient identifies one or more e-mail addresses which are to be used by the product once authenticated. Each of these addresses are configured in an address list with specified additional information (e.g. exact date and time sent out from the recipient), prior to authentication. The authentication process can be automatic, via a specified Simple Mail Transfer Protocol (SMTP) server on the internet, or can be done from the recipient's e-mail client by sending an authentication file as an e-mail attachment to a specified support address. In either case, the location of the specified SMTP server and the specified support address are predetermined and embedded in the product sent to the recipient. In particular, the e-mail address to which the request for authentication is sent is always marked as “authenticated” on the address list. An authenticating electronic mail message, with an attached authentication file (e.g. “authenticate.mlk”) is sent back to each e-mail address specified in the dialog by the recipient. This message conforms to the style and format of other Mail-Lock encrypted messages but has additional properties to serve the authentication process. It contains an access control list (ACL) of allowed recipients, and in particular the e-mail address (or addresses) specified by the recipient in the foregoing dialog, along with the specified additional information. When the attachment is opened, the address and specified information is checked against the stored address and specified information and if they match then the address is marked as “authenticated.”

Once an e-mail address is authenticated, then e-mails created by users of the product and sent to that recipient address can be read by the product reader at the recipient e-mail address. The e-mail, all e-mail attachments, and the policy from the sender are all encrypted. Access is allowed only if the authenticated recipient e-mail address matches an entry on the recipient e-mail address access control list (ACL) generated at the sender and contained in the encrypted e-mail. No server is required for normal operation of the invention.

The invention implements a method for controlling the downstream preservation and destruction of electronic mail by encrypting a message, the message consisting of an electronic mail message, an access control list containing an electronic mail address of a recipient, and a policy limiting use of the electronic mail message by the recipient. A reader for said recipient's electronic mail address is then authenticated, the reader being adapted to decrypt the message and apply the policy. The authenticated reader extracts the access control list from the encrypted message and determines whether the recipient's electronic mail address is on the access control list.

The reader provided to the recipient has an address list, there being a predetermined unlock address marked as authenticated on the address list. The reader sends out an authentication request message to a predetermined address, where the authentication request message contains the recipient's electronic mail address and a date time stamp. An authentication message is returned from the predetermined address, addressed to the recipient and having an access control list containing the predetermined unlock address, the recipient's electronic mail address and the date time stamp. The reader then uses the predetermined unlock address to decrypt the authentication message, and determines whether the recipient's electronic mail address and the date time stamp in the authentication message match the recipient's electronic mail address and date time stamp sent from the reader in the authentication request message.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow chart showing an overview of a preferred implementation of the invention.

FIG. 2 is a flow chart of that portion of the invention that creates an electronic mail message having the controls desired by the sender.

FIG. 3 is a flow chart of that portion of the invention that receives an electronic mail message from a sender and implements the controls desired by the sender.

FIG. 4 is a flow chart showing authentication of a recipient e-mail address in accordance with the invention.

FIG. 5 is a flow chart showing and alternate method for authentication of a recipient e-mail address in accordance with the invention.

FIG. 6 is a diagram showing the composition of a storage block containing the electronic mail message and its list of those to whom access is limited.

### DETAILED DESCRIPTION OF A PREFERRED EMBODIMENT OF THE INVENTION

Mail-Lock is a self-contained system that allows the creator of an e-mail to control the disposition of the e-mail once it has been sent. This is done via a Policy that is controlled by the creator of the e-mail before the e-mail is sent. The following actions are controlled:
Access to the e-mail—Who can open and view the e-mail is limited to the recipients of the e-mail.
Distribution of the e-mail—Printing, forwarding and copying of the e-mail can be controlled.
Distribution of the e-mail attachments—Printing, forwarding, and copying certain types of e-mail attachments can be independently controlled.
Expiration of the e-mail—the time period that the e-mail can be viewed and any allowed action taken against the e-mail can be limited.
Password—A password can be assigned to view the e-mail and take any allowed action against the e-mail.

The features of the present invention include the following:
The user can control printing, forwarding and copying of any sent e-mail.
The user can control printing, forwarding and copying of any Microsoft Office attachment.

The user can control the time period within which an e-mail and its attachments may be viewed. After the time period has expired, the recipient is blocked from viewing or manipulating the e-mail.
If copying is not allowed for the message, screen capturing is blocked both for the message and certain types of attachments when the recipient views them.
The recipient must authenticate his e-mail address. This process is done once when the product is initially used. The authentication process can be automatic, via a specified SMTP server on the internet, or by sending an authentication file to a specified support address as an e-mail attachment.
The e-mail, all e-mail attachments, and Policy are all encrypted. Access is only allowed if the authenticated recipient e-mail address matches the recipient e-mail address ACL contained in the e-mail.
No server is required for normal operation of the product

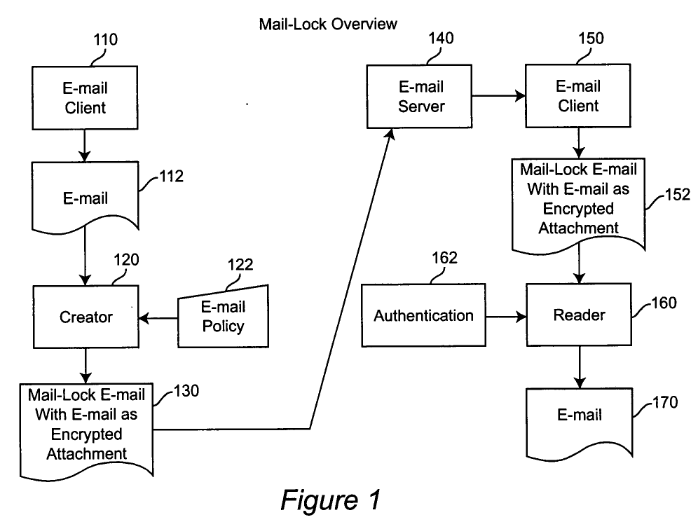

Referring now to the drawings, and more particularly to FIG. 1, there is shown an overview of the operation of the invention. The E-mail Client 110 of the sender creates an e-mail 112. The Mail-Lock Creator 120 reads the newly created e-mail 112 before it is sent and applies the E-mail policy 122 that has been entered by the sender. A Mail-Lock E-mail 130 is created with the original e-mail and e-mail policy encrypted in a Mail-Lock (.mlk) file attachment and the access control list (ACL) for the e-mail.

The e-mail 130 is sent to an e-mail server 140 via the normal mechanics of the e-mail client. The receiving e-mail client 150 receives the Mail-Lock E-mail 152 with the Mail-Lock (.mlk) file containing the original e-mail and the Mail-Lock E-mail. Since the .mlk file type is registered to run the Mail-Lock Reader 160, the Mail-Lock Reader 160 is invoked when the recipient opens the .mlk file attachment, and the Reader 160 then reads the attached Mail-Lock .mlk file and displays the e-mail 170 to the recipient. The Mail-Lock reader authenticates that the e-mail can be displayed based on the ACL in the e-mail and the defined Mail-Lock e-mail policy.

Mail-Lock Creator

The invention may be implemented to operate with any E-mail Client. For example, the Mail-Lock Creator is currently implemented as a COM Add-in for Microsoft Outlook. This enables it to intercept certain functions within the Outlook E-mail Client and add its controls to the normal Outlook E-mail Client such as a Send with Mail-Lock button on the Outlook Message window. Implementations of Mail-Lock for other e-mail clients will provide, at a minimum, that a user request to the e-mail client 110 to send an e-mail 112 is intercepted by the Mail-Lock Creator 120 as shown in FIG. 1.

The Mail-Lock E-mail Policy 122 is entered by the user to control the disposition of the e-mail after it has been sent. This is done via the Mail-Lock Policies dialog which is displayed when the user chooses to sent an e-mail using Mail-Lock. The Policy controls the following:
Distribution of the e-mail—Printing, forwarding and copying of the e-mail can be controlled.
Distribution of the e-mail attachments—Printing, forwarding, and copying of the e-mail's attachments can be independently controlled.
Expiration of the e-mail—the time period that the e-mail can be viewed and any allowed action taken against the e-mail can be limited.
Password—A password can be assigned to view the e-mail and take any allowed action against the e-mail.
   The Mail-Lock Policy is stored as a discreet data stream in the Mail-Lock E-mail file.

Mail Lock creates an Access Control List (ACL) for the Mail-Lock E-mail using the recipient address list for the e-mail. Each SMTP recipient address is hashed to a fixed length value using the same hash algorithm that is used to create the Authenticated E-mail Address List described below. Each hashed value is then added to the Access Control List structure. The Access Control List (ACL) is stored as a discreet data stream in the Mail-Lock E-mail file.

The Mail-Lock File is a registered file type with an extension of .mlk. It is associated with the Mail-Lock Reader so that when a user opens the file, for example, by double clicking on it, the Mail-Lock Reader is invoked to read the Mail-Lock File. The Mail-Lock file contains:
The original e-mail message in an encrypted form.
The original e-mail attachments in an encrypted form.
The Mail-Lock Policy in an encrypted form.
The Access Control List (ACL).
The random encryption key needed to decrypt all the encrypted elements.

In the current implementation of the invention with Outlook, there are two encryption algorithms used for Mail-Lock. The primary algorithm is Triple DES using the Microsoft: Enhanced Cryptographic Provider. This provides 168-bit encryption and is FIPS 140-1 Certification Numbers 16, 75 (Windows 85, Windows 98), 76 (Windows 2000), 103 (Windows 2000 SPx), 238 (Windows XP & Windows XP SP1). If the Microsoft: Enhanced Cryptographic Provider is not available (this would be on Windows NT 4.0, Windows 95, and Windows 98 with Internet Explorer 5.0 or earlier installed) then a Rijndael encryption algorithm is used instead using a 128-bit key. The encryption key is randomly generated and is stored in the Mail-Lock File to be used by the Mail-Lock Reader for decryption if the recipient has been authenticated as described below.

The Mail-Lock E-mail has two components. The first is the Mail-Lock Message. This is an e-mail that the Mail-Lock creator produces using the E-mail Client. It contains a message that the e-mail has been protected with Mail-Lock and where a free copy of the Mail-Lock Reader may be obtained. This message is only seen on an e-mail client that has not been integrated with Mail-Lock. An integrated client will automatically invoke the Mail-Lock Reader when it is opened. The second component is the Mail-Lock File which the Mail-Lock Creator creates as described above. The creator adds this file as an attachment to the Mail-Lock E-mail using the E-mail Client.

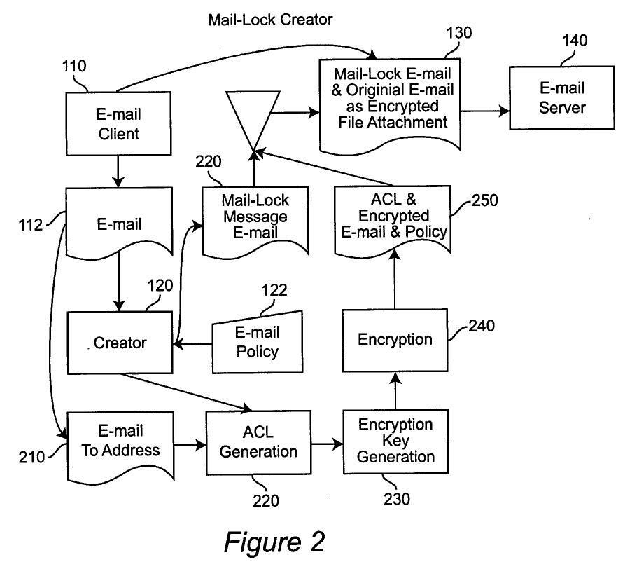

Turning now to FIG. 2, there is shown in greater detail how the creator 120 operates to generate the Mail-Lock E-mail 130 with the original e-mail as an encrypted file attachment. The E-Mail Client 110 creates an E-mail 112. At this point the sender has an option to send the E-mail using the Mail-Lock features. If the sender selects the Send-with-Mail-Lock option, the creator presents the sender with an E-mail Policy Dialog. In this dialog the user enters parameters that set the E-mail Policy 122 for the E-mail 112. The Creator generates a hashed ACL 220 for the e-mail based on the recipient list 210 of the E-mail. The Creator generates a random encryption key 230 and encrypts 240 both the E-mail 112 and the E-mail Policy 122. The Creator stores the ACL, the encrypted e-mail and the E-mail Policy in a Mail-Lock e-mail file (.mlk) at block 250. This file is a registered file type which is associated with the Mail-Lock Reader 160. The Creator creates a wrapper Mail-Lock Message e-mail 220 with instructions on where to download a free version of the Mail-Lock Reader. The Creator then attaches the Mail-Lock e-mail file 250 to the Mail-Lock Message e-mail 220, thereby creating the Mail-Lock E-mail 130 with the original e-mail as an encrypted file attachment. The E-mail Client sends the Mail-Lock Message e-mail 220 to the E-mail Server 140 as a normal e-mail with an attachment.

Mail-Lock Reader

As described above, the Mail-Lock E-mail has two components. The first is the Mail-Lock Message. The second the Mail-Lock File which the Mail-Lock Creator creates. The creator adds this file as an attachment to the Mail-Lock E-mail using the E-mail Client. The behavior of the E-mail client depends on whether the integrated Mail-Lock Creator package is installed

In the case where the integrated Mail-Lock Creator package is not installed, the E-mail Client will display the Mail-Lock Message e-mail. The Mail-Lock File will be shown as an attachment. If the Mail-Lock Reader is installed, the file type for the Mail-Lock file is registered and has been associated with the Mail-Lock Reader. When the user double clicks on the attachment or opens it with a context menu, the Mail-Lock Reader is invoked and reads the attached Mail-Lock file.

In the case where the integrated Mail-Lock Creator package is not installed, the Mail-Lock Creator automatically opens the Mail-Lock File with the Mail-Lock Reader as soon as the Mail-Lock E-mail is opened. The user never sees the Mail-Lock Message component of the Mail-Lock E-mail.

Authentication is where the Mail-Lock Reader compares each entry in the Access Control List (ACL) of the Mail-Lock File with the entries in the Authenticated E-mail Address List. These entries are derived from the SMTP E-Mail addresses entered by the user in the Mail-Lock Reader Authentication Process as described below. Mail-Lock has guaranteed that the registered recipients have access to the e-mails delivered to the e-mail addresses hashed in the authenticated E-mail Address List via that process. The entries in the Access Control List (ACL) and the Authenticated E-mail Address List are not actual SMTP address but are hashed from them using the same hash algorithm. The same SMTP address will always generate the same hash value using this algorithm. The Mail-Lock Reader compares each entry in the Access Control List (ACL) with each entry in the Authenticated E-mail Address List. If a match is found the processing continues. If no match is found the process is aborted.

Decryption occurs after Authentication is complete and verified as valid. The Reader first attempts to decrypt the encrypted streams using the Triple DES algorithm. If this fails it will use the Rijndael encryption algorithm. The encryption key is kept in the Mail-Lock file structure and is associated with the recipient's entry in the Access Control List (ACL). The Mail-Lock Policy, the original e-mail message and original e-mail attachments are all decrypted using the same key.

Once the E-mail Policy has been decrypted it is then examined by the Mail-Lock Reader to see if any constraints have been put on the e-mail. The following behavior can be controlled:
Distribution of the e-mail—Printing, forwarding and copying of the e-mail can be controlled. The reader will not allow printing or copying of the e-mail message unless specified in the policy. If the user attempts to use a screen capture program, the reader window is minimized and the clipboard is cleared. Print screen and all common screen capture control-key combinations are also disabled. If the Mail-Lock file is saved and copied to another machine or e-mailed, it cannot be opened unless one of the original recipients has authenticated their e-mail address.
Distribution of the e-mail attachments—Printing, forwarding, and copying certain types of e-mail attachments can be independently controlled. For example, implementation of the invention with Microsoft Outlook provides full control on Microsoft Office attachments and partial control on other file attachments. If the attachments are Microsoft Office documents, the distribution behavior is the same as the E-mail Message. If the attachment is another file type, control is only extended to saving the attachment using the Mail-Lock viewer. If the application associated with the attachment allows printing, or copying, the Mail-Lock implementation with Outlook cannot currently control this.
Expiration of the e-mail—the time period that the e-mail can be viewed and any allowed action taken against the e-mail can be limited. Mail-Lock creates an expiration date based on the policy time period to expire and the date the E-mail was created. If this date has passed the e-mail will not be displayed. Logic has been incorporated to detect if the machine date time has been turned back from the last time Mail-Lock was run. If it has, the Mail-Lock Reader will not display any e-mail with an expiration date.
Password—A password can be assigned to view the e-mail and take any allowed action against the e-mail. The password is stored as part of the policy. If a password was assigned, there is a prompt for the password before the e-mail is displayed.

The Mail-Lock Reader uses its own controls to display the email and to control its disposition. This is also done with Microsoft Office document attachments for the same reason. If an email has been copy protected by the Mail-Lock Policy, any attempt to maximize another window or change focus will result in the clipboard being cleared and the Mail-Lock Reader windows being minimized. This will also happen if control sequences normally used to capture a screen are used while a Mail-Lock Reader window is visible. This prevents the use of most screen capture utilities and any attempt to use the clipboard to copy the contents of a Mail-Lock email.

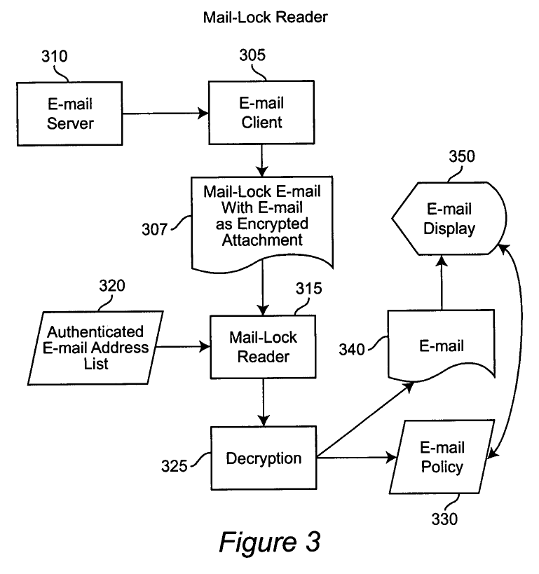

Turning now to FIG. 3, there is shown in greater detail how the E-mail Client 305 receives the Mail-Lock e-mail from the E-mail server 310. The Mail-Lock e-mail is contained as a Mail-Lock E-mail File (.mlk) attachment to the Mail-Lock E-mail 307. The .mlk file type is registered with an association with the Mail-Lock Reader executable 315. When the user opens the Mail-Lock E-mail File 307, the Mail-Lock Reader 315 is invoked and the file is passed to it to read. The Mail-Lock Reader 315 reads the ACL from the Mail-Lock E-mail File 307, and the Mail-Lock Reader 315 compares each entry in the ACL with the entries in the Authenticated E-mail Address List 320. If a match is found the processing continues. If no match is found the process is aborted. The Mail-Lock E-mail Policy 330 and the e-mail message 340, including attachments, are decrypted at block 325. The Mail-Lock E-mail Policy 330 is checked for expiration and its other rules are evaluated. If the policy permits, the Mail-Lock Reader displays the e-mail 350.

Mail-Lock Reader Authentication

For the Mail-Lock concept to work, a sender must have assurance that the e-mail will be opened only by designated recipients. In order to open an e-mail sent with Mail-Lock, a recipient must have a copy of the Mail-Lock Reader, which may be downloaded from a central server without charge. Those skilled in the art will also understand that the Mail-Lock Reader may also be provided through alternative distribution mechanisms, such as being included in a distribution of pre-configured hardware or software. However, since the Reader is free it may be obtained by anyone, including those who may improperly come into possession of an email intended for another recipient. In order to prevent use of a copy of the Mail-Lock Reader as a “universal key”, the invention provides for authenticating the Mail-Lock Reader so that it is usable to unlock only mail directed to addresses owned by, and validated to, a particular user.

This is accomplished by a procedure similar to the “call back” protocol for confirming the identity of a caller. According to this conventional protocol, dial-in access to a system is allowed only to identify a pre-arranged number, which the system will then use on a dial-out basis to establish a connection. In the present invention, a user downloads a copy of the Mail-Lock Reader to a particular system having an e-mail client for servicing particular e-mail accounts. The downloaded copy of Mail-Lock Reader is unable to unlock any e-mail, because its Authenticated E-mail Address List is blank. In order to unlock a Mail-Lock E-mail, the Mail-Lock Reader must find at least one address in the e-mail's Access Control List that matches an address in the Authenticated E-mail Address List. In accordance with the invention, as described in detail below, the user who has downloaded a copy of the Mail-Lock Reader enters the e-mail addresses serviced by his e-mail client. These are recorded in an Unauthenticated Address List, together with a date and time indication. The Mail-Lock Reader also places a predetermined unlock address in its Authenticated E-mail Address List.

While more than one e-mail address may be entered for authentication, one e-mail address may be sufficient. In a typical scenario, the user has received a Mail-Lock E-mail at a particular e-mail address, and this e-mail includes an instruction for a free download of the Mail-Lock Reader. In order to read the e-mail, this particular e-mail address must be entered and then authenticated to the downloaded Mail-Lock Reader.

Whether one e-mail address or more than one is entered, for each entered e-mail address, the Mail-Lock Reader automatically constructs a specially configured e-mail, which includes a) the information placed in the Unauthenticated Address List and b) a predetermined Mail-Lock policy designed, as explained hereafter, to serve the needs of the authentication process. In addition, the Access Control List for the specially configured e-mail will include a predetermined unlock address. The specially configured e-mail is then sent, via a known SMTP Server, to the entered e-mail address. Note that if an entered e-mail address is not an address that terminates at the particular user location where the copy of Mail-Lock Reader has been downloaded, the specially configured e-mail will not return and the entered e-mail address will not be authenticated at that particular user location. This prevents someone who has intercepted the Mail-Lock message from being able to fool his downloaded copy of the Reader into thinking that the specially configured e-mail has been returned to the entered e-mail address.

When the specially configured e-mail is returned to the user's e-mail server, the Mail-Lock Reader will find a match between the predetermined unlock address on the Access Control List and the same predetermined unlock address stored in the Authenticated Address List, thereby allowing the Mail-Lock Reader to open the specially configured e-mail. The special configuration assures that the entered e-mail address to which the e-mail is returned is then checked against the corresponding entry in the Unauthenticated Address list. If there is a match, the entered e-mail address is then added to the Authenticated E-mail Address List, completing the authentication process. In this manner, Mail-Lock guarantees that the registered recipients have access to the e-mail sent to the registered address.

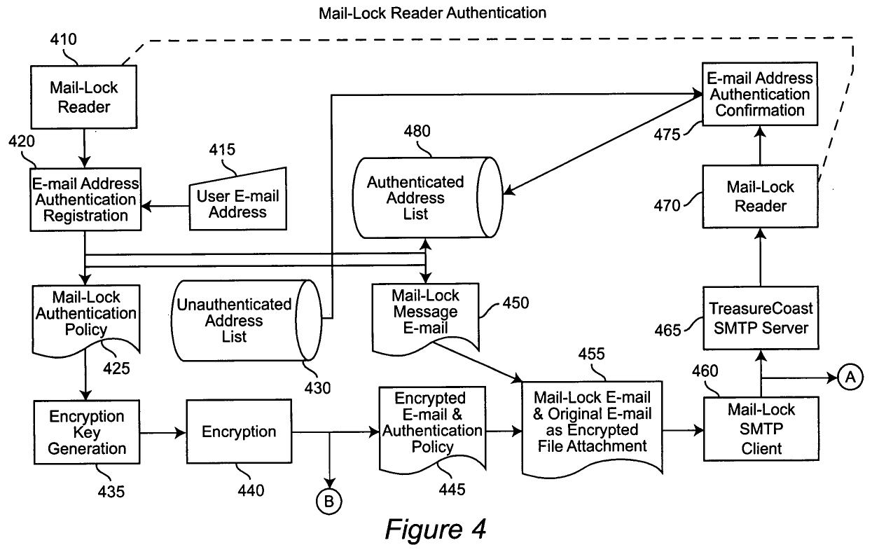

The Mail-Lock Reader Authentication process will now be described in detail with reference to FIG. 4. The downloaded Mail-Lock Reader 410 presents the user with a Mail-Lock Registration dialog, where the user enters (at block 415) all the e-mail addresses that the user uses to receive e-mail. A predefined unlock address is added to the Authenticated Address List 480. For each e-mail address entered by the user, the following steps for authentication and registration 420 are completed. On the user's machine, the e-mail address and the current date/time are recorded in an Unauthenticated Address List 430. A Mail-Lock Authentication Policy 425 is created with the same information that was recorded to the Unauthenticated Address List 430. The policy 425 contains an expiration date 7 days in the future, which should allow sufficient time for receipt validation and at the same time prevent use of an outdated authentication e-mail. A Mail-Lock Authentication E-mail is then created and a random encryption key 435 is generated. The Mail-Lock Authentication Policy 425 and Mail-Lock E-mail are encrypted 440 and placed in a Mail-Lock E-mail File 445 (.mlk file type). Mail-Lock creates a wrapper Mail-Lock Message E-mail 450 with instructions on how to complete the authentication process using the Mail-Lock Reader. Mail-Lock attaches the encrypted Mail-Lock e-mail file 445 to the Mail-Lock Message E-mail 450 at block 455.

The Mail-Lock SMTP client 460 at the user's machine then connects to a known SMTP server (e.g. the TreasureCoast SMTP Server) 465, which then sends the Mail-Lock Message E-mail 450 with the Mail-Lock Authentication attachment 445 to the address to be authenticated. The Mail-Lock Message E-mail 450 with the Mail-Lock Authentication attachment 445 is received back by the user's e-mail client 460. User attempts to read the message invoke the Mail-Lock Reader 470 (same as Mail-Lock Reader 410, connected by a dashed line and shown separately for convenience in display on FIG. 4). The Mail-Lock Reader 470 checks each name in the e-mail's recipient list against the Authenticated Address List 480 to confirm that the e-mail is intended for the user of Mail-Lock Reader 470. Because this is an authentication e-mail, the Access Control List (ACL) will include the predetermined unlock address. Because this address had earlier been added to the Authenticated Address List 480, the Mail-Lock Reader 470 will find a match. This allows the user to open the Mail-Lock Authentication attachment. The Mail-Lock Reader 470 examines the policy and recognizes that the e-mail is an Authentication e-mail, and then performs the steps necessary to confirm the authentication 475. The authentication policy 425 is validated as it would be with any Mail-Lock E-mail. The authentication e-mail address, date and time contained in the e-mail are checked against the same information recorded in the Unauthenticated Address List 430. If a match is found an entry is created in the Authenticated Address List 480 for the e-mail address. The e-mail message is then displayed by the Mail-Lock Reader 470, stating that the message was a Mail-Lock Authentication.

The E-mail Address Registrations dialog for user entry of one or more e-mail addresses for authentication, described above, is presented to the user the first time the Mail-Lock Reader or Mail-Lock Creator is used. The dialog may also be initiated from the start menu/Mail-Lock/Register Users option, which runs the Mail-Lock Reader with a special command line switch. The Mail-Lock Authentication Policy 425 is a standard Mail-Lock Policy with no copying allowed and an expiration set to 7 days from the date and time the Mail-Lock Authentication process was started. The encryption key generation process 435, as well as the algorithms used in encryption 440, is identical to the corresponding items 230 and 240 shown in FIG. 2 for the normal Mail-Lock Creator process.

The Mail-Lock Authentication E-mail 455 contains two components. The first component is the Mail-Lock Message E-mail 450 that gives instructions on how to complete the authentication process. The second component is a Mail-Lock Authentication E-mail file 445. This is a special Mail-Lock e-mail file that contains the Mail-Lock Authentication Policy 425, an Access Control List (ACL) set to the predetermined unlock address, and an e-mail which states that the email is a Mail-Lock Authentication E-mail. The Mail-Lock E-mail file is an attachment to the Mail-Lock Message E-mail. The Mail-Lock SMTP Client 460 constructs an e-mail containing both components for each entry in the Unauthenticated Address List, and forwards them to the known SMTP Server 465.

The Mail-Lock SMTP client 460 is a general SMTP client that uses Windows Sockets (Winsock) processing. It is set to connect to the known SMTP server 465 using a predetermined username and password. These are not user accessible in order to control the authentication process. The SMTP client is then instructed by Mail-Lock to mail a Mail-Lock Authentication E-mail to each of the SMTP e-mail addresses in the Unauthenticated Address List 430. The known SMTP Server 465 is a standard SMTP server at a fixed domain name that cannot be changed by the user. It does not do any actual processing other than to send each of the Mail-Lock Authentication E-mails to the SMTP address requested by Mail-Lock.

The user attempts to open the Mail-Lock Authentication attachment, thereby invoking the Mail-Lock Reader in the same manner as with any normal Mail-Lock E-mail file. The Reader authenticates the ACL, which includes the predetermined unlock address, against the predetermined unlock address in the Authenticated Address List. It then decrypts the Mail-Lock Policy and authentication e-mail much as it does a regular Mail-Lock E-mail. The Mail-Lock Reader examines the policy and recognizes that the e-mail is an authentication e-mail. The policy is validated as it would be with any Mail-Lock E-mail. Then the Mail-Lock Reader checks the Authentication e-mail address, date and time contained in the decrypted e-mail against the Unauthenticated Address List. If a match is found an entry is created in the Authenticated Address List for the e-mail address. This entry is a hashed value of the authenticated SMTP email address. A field is updated in the Unauthenticated Address List for the entry, marking it as authenticated. Then the e-mail message is displayed by the reader, which states that the message was a Mail-Lock Authentication. This is done regardless of whether a match was found.

Mail-Lock Reader Manual Authentication

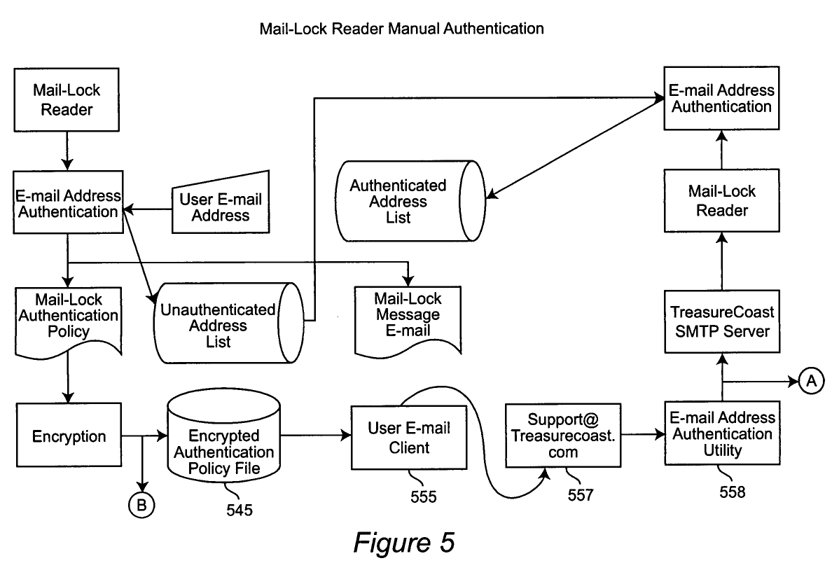

In some circumstances the Mail-Lock SMTP Client 460 may fail to connect to the SMTP server 465. This can happen for a number of reasons, one being if a firewall is blocking SMTP outbound mail. Therefore, the authentication process in this situation is the same as the Mail-Lock Authentication process detailed in connection with FIG. 4 up to the point where the email is sent by the Mail-Lock SMTP Client 460. At this point the SMTP Client fails to send an email and the process diverges from the normal Mail Lock Authentication process, as will now be described with reference to FIG. 5.

When the Mail-Lock SMTP Client 460 is unable to establish a connection with the SMTP Server 465, a message is displayed to the user describing an alternative procedure. In the alternative procedure, the Mail-Lock Reader creates an encrypted text file 545, instead of an encrypted .mlk file 445. The encrypted text file 545 contains the same components as the encrypted .mlk file 445, including the Authentication Policy 425 and an Access Control List (ACL) set to the predetermined unlock address. The encrypted text file is made available to the user (e.g. placed on the user desktop). The user then prepares an e-mail addressed to a known support address (e.g. support@treasurecoastsoftware.com) 557, attaches the encrypted text file, and sends the e-mail via the user's e-mail client 555. An Authentication Utility 558 at the known support address then uses the encrypted text file 545 to construct an encrypted Mail-Lock E-mail and Authentication Policy (as in block 445) and attach it to a Mail-Lock Message E-mail (as in block 455). The Authentication Utility 558 then sends the e-mail with attachment to the known SMTP Server 465, where the authentication process continues as described in connection with FIG. 4.

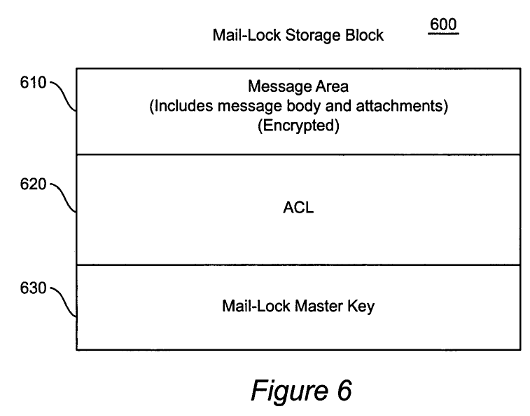

The security architecture of the invention may be described with reference to FIG. 6, which shows a Mail-Lock storage block 600. The storage block 600 is created when a Mail-Lock message is created and contains three parts: the message 610 itself; an Access Control List (ACL) 620; and the Mail-Lock Master Key 630. When the user creates an e-mail and selects a policy, the e-mail and attachments are encrypted, e.g. using a random number encryption scheme using a unique global identifier. In such an implementation the unique global identifier is then placed in the ACL stream 620 in storage block 600 and further encrypted with a key derived from the list of recipients. The result of this further encryption is then stored in the ACL stream 620. The Mail-Lock Master Key 630 is then used with a hashing algorithm to encrypt the entire storage block 600.

While the invention has been described in terms of a single preferred embodiment, those skilled in the art will recognize that the invention can be practiced with modification within the spirit and scope of the appended claims.

1. A system for controlling the downstream preservation and destruction of electronic mail, comprising:
means for encrypting a message, the message consisting of an electronic mail message, an access control list containing an electronic mail address of a recipient, and a policy limiting use of said electronic mail message by said recipient; and
means for authenticating a reader for said recipient's electronic mail address, said authenticated reader being adapted to decrypt said message and apply said policy,
wherein said authenticated reader extracts said access control list from said encrypted message and determines whether said recipient's electronic mail address is on said access control list.

2. A system as is claim 1, wherein a sender of said electronic mail message determines said policy through a dialog provided within an electronic mail client of said sender.

3. A system as in claim 2, wherein said policy dialog is provided by a plug-in to said sender's electronic mail client.

4. A system as in claim 2, wherein said policy dialog includes determining whether said reader of said recipient will allow printing of said electronic mail message.

5. A system as in claim 4, wherein said policy dialog includes means for determining whether said reader of said recipient will allow printing of attachments to said electronic mail message.

6. A system as in claim 1, wherein said means for authenticating further comprise:
means for providing said reader to said recipient, said reader having an address list, there being a predetermined unlock address marked as authenticated on said address list;
means for sending from said reader an authentication request message to a predetermined address, said authentication request message containing said recipient's electronic mail address and a date time stamp;
means for receiving from said predetermined address an authentication message addressed to said recipient, said authentication message having an access control list containing said predetermined unlock address, said recipient's electronic mail address and said date time stamp; and
means for using said predetermined unlock address to decrypt said authentication message, and determining whether said recipient's electronic mail address and said date time stamp in said authentication message match the recipient's electronic mail address and date time stamp sent from said reader.

7. A system as in claim 6, wherein said reader is provided to said recipient in response to a request from said recipient's email client to said predetermined address.

8. A system as in claim 6, wherein said reader is pre-packaged in said recipient's email client.

9. A system as in claim 7, wherein said predetermined address is a location of a web server and said authentication request message is sent automatically by a simple mail transfer protocol (SMTP) client within said reader.

10. A system as in claim 7, wherein said predetermined address is a known electronic mail support address and said authentication request message is a text file encrypted by said reader and sent by said recipient's email client.

11. A method for controlling the downstream preservation and destruction of electronic mail, comprising the steps of:
encrypting a message, the message consisting of an electronic mail message, an access control list containing an electronic mail address of a recipient, and a policy limiting use of said electronic mail message by said recipient; and
authenticating a reader for said recipient's electronic mail address, said authenticated reader being adapted to decrypt said message and apply said policy,
wherein said authenticated reader extracts said access control list from said encrypted message and determines whether said recipient's electronic mail address is on said access control list.

12. A method as is claim 11, wherein a sender of said electronic mail message determines said policy through a dialog provided within an electronic mail client of said sender.

13. A method as in claim 12, wherein said policy dialog is provided by a plug-in to said sender's electronic mail client.

14. A method as in claim 12, wherein said policy dialog includes determining whether said reader of said recipient will allow printing of said electronic mail message.

15. A method as in claim 14, wherein said policy dialog includes determining whether said reader of said recipient will allow printing of attachments to said electronic mail message.

16. A method as in claim 11, wherein said authentication step further comprises the steps of:
providing said reader to said recipient, said reader having an address list, there being a predetermined unlock address marked as authenticated on said address list;
sending from said reader an authentication request message to a predetermined address, said authentication request message containing said recipient's electronic mail address and a date time stamp;
receiving from said predetermined address an authentication message addressed to said recipient, said authentication message having an access control list containing said predetermined unlock address, said recipient's electronic mail address and said date time stamp; and
using said predetermined unlock address to decrypt said authentication message, and determining whether said recipient's electronic mail address and said date time stamp in said authentication message match the recipient's electronic mail address and date time stamp sent from said reader.

17. A method as in claim 16, wherein said reader is provided to said recipient in response to a request from said recipient's email client to said predetermined address.

18. A method as in claim 16, wherein said reader is pre-packaged in said recipient's email client.

19. A method as in claim 17, wherein said predetermined address is a location of a web server and said authentication request message is sent automatically by a simple mail transfer protocol (SMTP) client within said reader.

20. A method as in claim 17, wherein said predetermined address is a known electronic mail support address and said authentication request message is a text file encrypted by said reader and sent by said recipient's email client.
